(19) United States
(12) Patent Application Publication
(10) Pub. No.: US 2008/0291315 A1
(43) Pub. Date: Nov. 27, 2008

(54) DIGITAL IMAGING SYSTEM HAVING GPS FUNCTION AND METHOD OF STORING INFORMATION OF IMAGING PLACE THEREOF

(75) Inventor: Seong Ho Yoon, Gangnam-gu (KR)

Correspondence Address: MERCHANT & GOULD PC, P.O. BOX 2903, MINNEAPOLIS, MN, 55402-0903, US

(73) Assignee: NAMSUNG CO., LTD, Guro-gu (KR)

(21) Appl. No.: 11/751,941

(22) Filed: May 22, 2007

(51) Int. Cl. H04N 5/222; G01S 5/00; H04N 5/76

(52) U.S. Cl. 348/333.01; 342/357.08; 348/231.3; 348/E05.024

(57) ABSTRACT

The invention relates to a digital imaging system and a method of storing imaging place information thereof. In the digital imaging system having a GPS function, imaging place information, such as photographs and location of imaging places to be remembered, are stored together, such that a user can easily visit the image places again. Further, positional information of an imaging place associated with a photograph is automatically set as a destination, thereby performing the GPS function. In addition, a place to visit for photographing is set as at least one destination, and information regarding the set destination is input in advance to be then stored and displayed.

### BACKGROUND OF THE INVENTION

1. Field of the Invention

The present invention relates to a digital imaging system and a method of storing imaging place information thereof, and in particular, to a digital imaging system having a GPS function and a method of storing imaging place information thereof.

2. Description of the Related Art

The GPS (Global Positioning System) is a system that is also referred as a satellite positioning system. The GPS is usually mounted on a vehicle so as to receive electric waves for positioning to be simultaneously transmitted from 24 satellites, which are at an altitude of approximately 20,000 km, to the ground every second, and to display GPS data on a numerical map so as to three-dimensionally show the current position (latitude, longitude, and altitude) of a receiver. For example, there is known a navigation system that can receive positional information while driving.

The GPS function of the navigation system may be used through an additional device having a navigation function mounted on a vehicle, a vehicle information terminal that provides a GPS function together with traffic information or weather information, or a cellular phone that supports a GPS function.

In general, the in-vehicle navigation system includes primarily a navigation controller that can three-dimensionally calculate the current position of a vehicle by receiving the electric waves for positioning transmitted from the GPS satellites. In addition to the navigation controller, the in-vehicle navigation system further includes a database that stores geographical information regarding roads and traffic facilities of an area where the vehicle is being driven, and a display device that displays information obtained from the navigation controller and the database to a driver.

The navigation system stores a road map captured by the satellite as a database in a predetermined storage medium, displays the current position of the vehicle while driving on the road map and, if the driver sets a desired target point, searches for all paths between the start point and the target point, and displays the shortest path on the display device, making driving more convenient. However, since a control chip, such as a CPU (Central Processing Unit) or the like, which is used as the controller of the navigation system, is expensive while it has only a navigation function, it is unprofitable.

In recent years, there is known a digital camera as an imaging device that captures an image and stores the captured image as digital data. In addition to the digital camera, there are known various portable digital imaging systems, such as camcorders, camera-equipped cellular phones, camera-equipped electronic organizers, and PDAs (Personal Data Assistants).

A user can carry along with the portable digital imaging systems while traveling or climbing a mountain and can capture images of various scenes and electronically record the captured images using the portable digital imaging system.

However, the portable digital imaging system supports only functions of taking, storing, and searching photographs, but cannot store information of a place where the photograph is taken or specific information regarding an imaging place. Accordingly, it is difficult for the user to remember the locations of various destinations and the places visited even though he/she sees the photographs taken at various destinations and visited places for a further visit. Accordingly, there is a trouble in that, if the user visits the destination again, he/she needs to search information regarding roads to the destination. Further, in the portable digital imaging system, there is no method of effectively storing information regarding the captured images after photographing.

Therefore, if it is configured such that, when the captured images are stored in the portable digital imaging system, imaging place information acquired using a GPS function is stored together with the captured images, the above-described problem will be solved, and various additional effects will be obtained.

### SUMMARY OF THE INVENTION

The invention has been finalized in order to solve the above-described problems, and an object of the invention is to provide a digital imaging system having a GPS function that stores photographs of destinations to remember and imaging place information together and to a method of storing imaging place information thereof.

Another object of the invention is to provide a method of storing imaging place information for a digital imaging system having a GPS function that can perform the GPS function by automatically setting positional information of an imaging place associated with a photograph as a destination.

Still another object of the invention is to provide a method of storing imaging place information for a digital imaging system having a GPS function that can set a place to visit for photographing as at least one GPS destination and input information regarding the set destination in advance to be then stored and displayed.

According to an aspect of the invention, a digital imaging system includes a camera unit that captures an image, digital converts the captured image, and outputs the converted image, an image processing unit that compresses the image captured by the camera unit, a GPS module that receives GPS positional information, a data storage unit that stores GPS map data, a key input unit that has a shot button, a GPS operating button, and various input buttons, a display unit that displays the captured image and the GPS positional information, and a control unit that, when an image captured by the camera unit according to the operation of the key input unit is stored, controls the data storage unit to store positional information of an imaging place received by the GPS module as imaging place information together with the captured image and, when the captured image is read, controls the display unit to display the imaging place information.

### BRIEF DESCRIPTION OF THE DRAWINGS

The above and other features and advantages of the present invention will become more apparent by describing in detail preferred embodiments thereof with reference to the attached drawings in which:

FIG. 1 is a control block diagram of a digital imaging system according to an embodiment of the invention;

FIG. 2 is a block diagram showing the internal configuration of a camera unit shown in FIG. 1;

FIG. 3 is a control flowchart illustrating a method of capturing an image and storing imaging place information in a digital imaging system having a GPS function according to a first embodiment of the invention;

FIG. 4 is a control flowchart illustrating a method of setting a GPS destination using a captured image in a digital imaging system having a GPS function according to a second embodiment of the invention; and

FIG. 5 is a control flowchart illustrating a method of storing sound data and text data in association with a plurality of set destinations in a digital imaging system having a GPS function according to a third embodiment of the invention.

### DESCRIPTION OF THE PREFERRED EMBODIMENTS

Hereinafter, preferred embodiments of the invention will be described in detail with reference to the accompanying drawings.

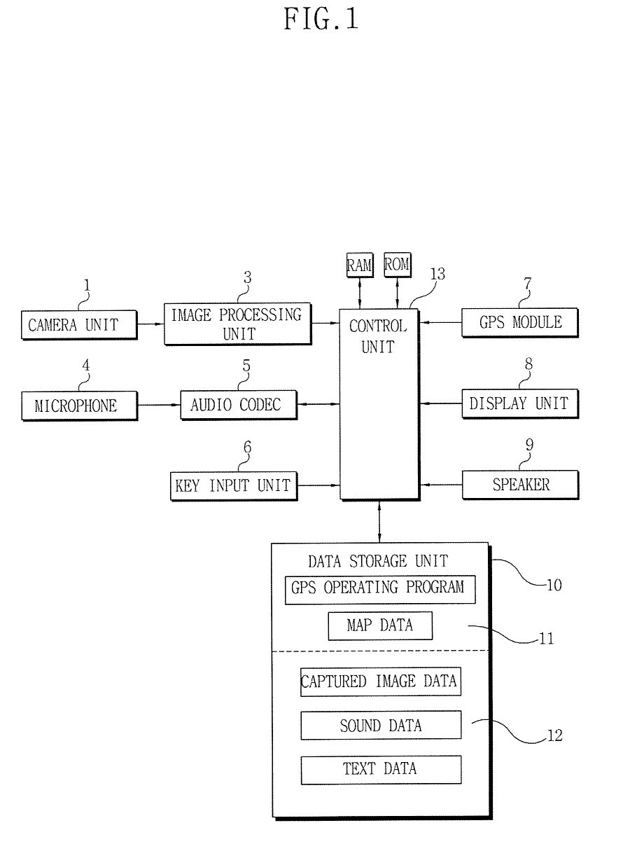

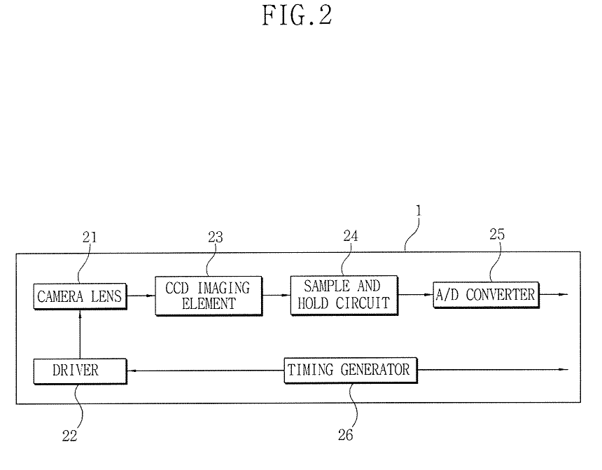

FIG. 1 is a control block diagram of a digital imaging system having a GPS function according to an embodiment of the invention. FIG. 2 is a block diagram showing the internal configuration of a camera unit shown in FIG. 1. As shown in FIG. 1, the digital imaging system includes a camera unit 1 that outputs a captured image, an image processing unit 3 that processes the captured image output from the camera unit 1, a GPS module 7 that receives GPS positional information, a microphone 4 that converts sound from a user into an electrical signal, an audio codec 5 that compresses/decompresses the electrical signal of sound, a data storage unit 10 that stores the captured image captured by the camera unit 1, imaging place information, and map data, a ROM that stores device information of the camera unit 1, the GPS module 7, the image processing unit 3, and the audio codec 5, a RAM that temporarily stores data during the operation of a control unit 13, and the control unit 13 that controls the operations of the camera unit 1, the GPS module 7, and the microphone 4 on the basis of the device information stored in the ROM and controls the data storage unit 10 to store the captured image, sound data, or text according to an input from a key input unit 6 together with the GPS positional information.

As shown in FIG. 2, the camera unit 1 includes a camera lens 21, a CCD imaging element (hereinafter, referred to as ‘CCD’) 23 that picks-up light incident from the camera lens 21, a CCD driver 22 that drives the CCD, a timing generator 26 that generates various timing signals including a signal to control charging time (imaging time) of the CCD, a sample and hold circuit 24 that samples an imaging signal from the CCD 23 so as to remove noise, and an A/D converter 25 that converts the imaging signal with no noise into digital data and output the converted digital data. The camera unit 1 converts the captured image into digital data and outputs the converted digital data.

The image processing unit 3 compresses the digital-converted captured image.

The imaging place information includes GPS positional information of an imaging place received by the GPS module 7 while photographing, sound data input through the microphone 4, and text data input through the key input unit 6.

The data storage unit 10 includes an internal memory 11 that stores a GPS operating program and GPS map data, and a removable memory card 12 that stores the captured image.

Here, the removable memory card 12 also stores GPS positional data received by the GPS module 7 while photographing, text data input through the key input unit 6, and sound data input through the microphone 4. For example, the removable memory card 12 may be an SD (Secure Digital) card, a CF (Compact Flash) card, an MMC (MultiMedia) card, or an SMC (Smart Media Card).

The key input unit 6 has a primary button to execute a camera function for capturing an image and searching the captured image. The key input unit 6 also has a GPS function execution button (not shown) to execute the GPS function according to an embodiment of the invention, a up/down/left/right directional button to set a GPS destination, a sound recording execution button (not shown) to receive sound and store the received sound in association with the captured image, and a text input button (not shown) to receive a text and store the received text in association with the captured image. Here, the text input button has input buttons for inputting numerals, Korean characters, and English characters.

The control unit 13 receives a signal from a GPS satellite through an antenna of the GPS module 7, detects the position of a user who carries the digital imaging system, synthesizes map data and information regarding a current position, and outputs the current position of the user to the display unit 8 so as to be displayed on a road map of the map data. Further, the control unit 13 measures the current position of the user and displays the measured current position on the road map using a positional cursor.

Further, according to the embodiment of the invention, if an imaging place storage function is selected through the key input unit 6 when the image data obtained from the camera unit 1 is stored, the control unit 13 stores the information regarding the current position received by the GPS module 7 in the data storage unit 10 together with the image data.

When a sound storage function is selected through the key input unit 6, the control unit 13 converts sound input through the microphone 4 into sound data using the audio codec 5 and stores the converted sound data together with the image data. Further, if a text storage function is selected, the control unit 13 stores the text input through the key input unit 6 together with the image data.

If play of the captured image data is selected through the key input unit 6, when reading the image data, the control unit 13 checks whether or not GPS positional data and sound data are stored in the data storage unit 10 together with the image data.

If the GPS positional information is stored, the control unit 13 controls the display unit 8 to display map data relative to the GPS positional information together with the GPS positional information. Further, the control unit 13 reads out the sound data stored together with the image data, decompresses the sound data, and outputs the decompressed sound data through the speaker 9.

The digital imaging system according to the embodiment of the invention additionally has another function for searching the captured image and automatically setting the GPS positional information as a GPS destination when the GPS positional information is displayed. Accordingly, in a state where the searched captured image and the imaging place information are displayed on the display unit 8, the GPS function is automatically performed through the operation of the key input unit 6, such that the imaging place information can be set as the GPS destination.

Meanwhile, the digital imaging system having a GPS function according to the embodiment of the invention additionally has a function for performing the GPS function so as to set a plurality of destinations and storing image data, sound data, and text data in association with the set destinations. Further, if the user arrives at the corresponding destination, the image data, the sound data, and the text data in association with the destination can be read and displayed.

Accordingly, if an instruction to execute the GPS function is input through the key input unit 6, the control unit 13 receives and sets the GPS destination and stores the set GPS destination in the data storage unit 10. Further, while the user is traveling along with the digital imaging system, the control unit 13 receives the information regarding the current position in real time by the GPS module 7 and checks whether or not the user arrives at the set destination.

If the user arrives at the set destination, the control unit 13 reads outs image data and text data associated with the destination from the data storage unit 10 and displays the read image data and text data on the display unit 8. In addition, the control unit 13 reads out sound data associated with the destination and outputs the read sound data to the speaker.

The digital imaging system having a GPS function according to the embodiment of the invention may have a function of storing travel information in the data storage unit 10 in advance before traveling so as to be displayed on a map using a USB port (not shown) or other storage mediums (SD cards, MMC cards, CF cards, and Smart Card).

Specifically, in addition to the captured images, the sound data input through the microphone, and text data input through the key input unit by the user, the digital imaging system can display, on a map, image data, sound data, or text data input through an external data input/output port, such as a USB port or the like, if it reaches a GPS position corresponding to the GPS destination.

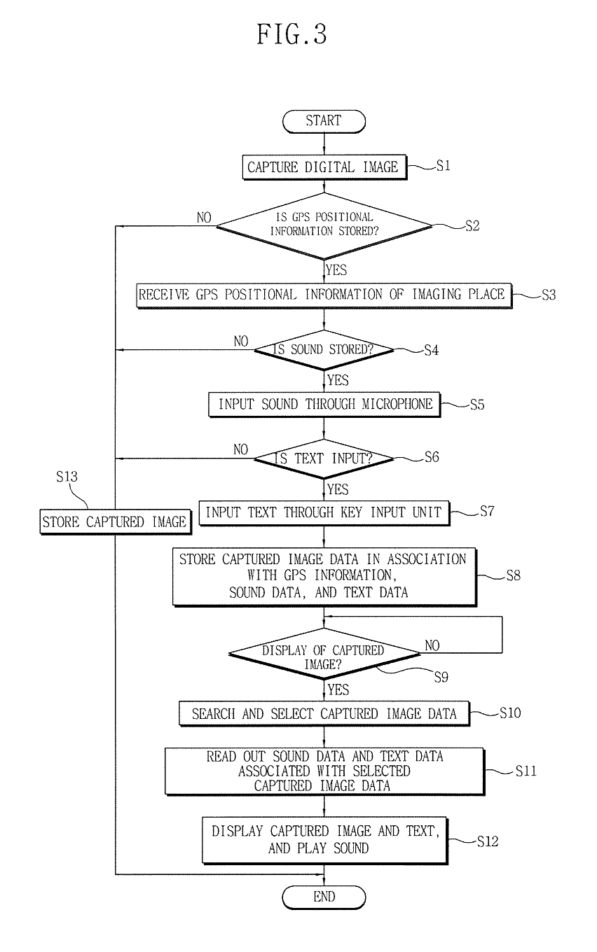

FIG. 3 is a control flowchart illustrating a method of capturing an image and storing an imaging place in a digital imaging system having a GPS function according to a first embodiment of the invention.

As shown in FIG. 3, at Step S1, a digital image is captured by the camera unit 1 of the digital imaging system. At Step S2, the user operates the key input unit 6 to select whether or not to store GPS positional information.

As the result at Step S2, if the storage of the GPS positional information is selected, at Step S3, the control unit 13 operates the GPS module 7 to receive the GPS positional information of the imaging place.

At Step S4, the user operates the key input unit 6 to select whether or not to store sound. As the result at Step S4, if the storage of sound is selected, at Step S5, the control unit 13 operates the microphone 4 to receive sound.

At Step S6, a text is input through the operation of the key input unit 6. As the result at Step S6, if the input of a text is selected, at Step S7, the control unit 13 receives a text through the key input unit 6.

At Step S8, the control unit 13 stores the captured image data in association with GPS positional information, sound data, and text data.

At Step S9, if display of a captured image is selected, at Step S10, the control unit 13 searches and selects image data according to the operation of the key input unit 6.

At Step S1, sound data and text data associated with the selected image data are read out. At Step S12, the read image and text are displayed on the display unit 8, and the sound data is played and outputs to the speaker 9.

According to the above-described procedure, an image can be captured by the digital imaging system and stored in association with GPS positional information, sound data, and text data. Then, when image data is searched and displayed, GPS positional information, sound data, and text data associated with the image data can be displayed.

The image data, sound data, and text data may include image data, sound data, and text files input from the outside through a USB port or a removable memory card, as well as image data, sound data, and text data generated by the user using the digital imaging system.

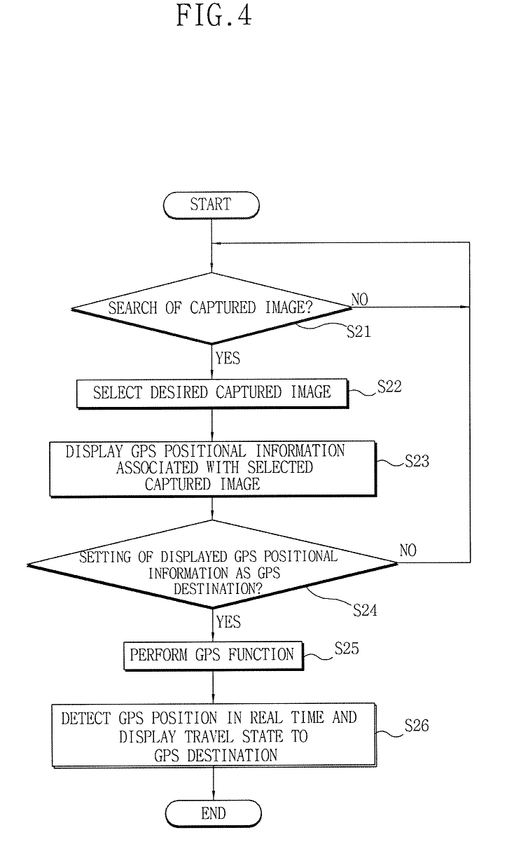

FIG. 4 shows, in a digital imaging system having a GPS function according to a second embodiment of the invention, the control operation of the digital imaging system in a case where GPS positional information stored in association with a captured image is set as a GPS destination, thereby using the GPS function.

As shown in FIG. 4, at Step S21, a captured image search button (not shown) in the key input unit 6 of the digital imaging system is selected. At Step S22, the captured images are searched through the operation of the key input unit 6, and a desired captured image is selected.

At Step S23, the control unit 13 displays the selected captured image and GPS positional information associated with the captured image. At Step S24, the control unit 13 automatically perform the GPS function, and sets the GPS positional information displayed on the display unit 8 as the GPS destination.

At Step S25, the control unit 13 detects GPS positional information in real time through the GPS module 7 and displays the travel state to the destination.

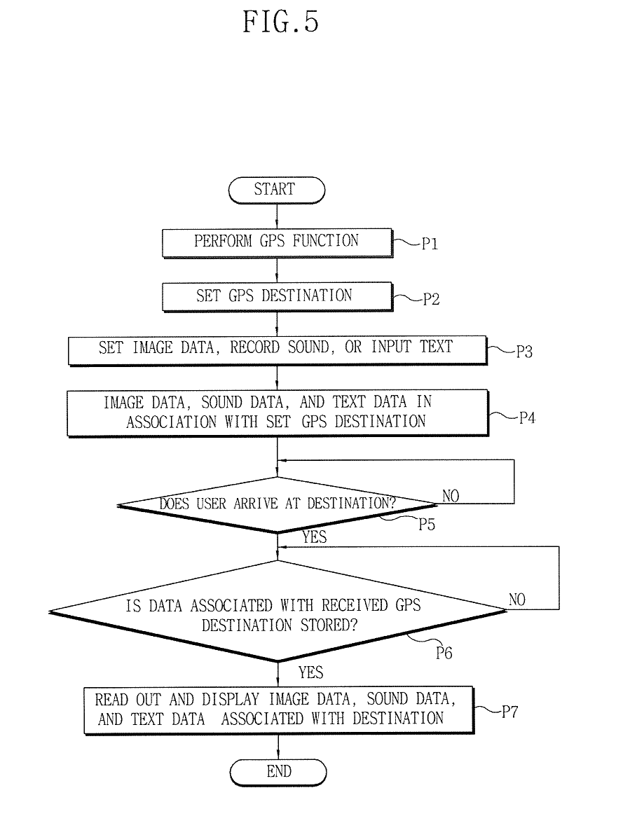

FIG. 5 shows, in a digital imaging system having a GPS function according to a third embodiment of the invention, the control operation of the digital imaging system in a case where a plurality of GPS destinations are set, image data, sound data, and text data are input according to the set destinations and stored in advance, and image data, sound data, and text data are read out and displayed each time a user travels to the set destination and arrives at the GPS destination.

As shown in FIG. 5, at Step P1, the GPS function of digital imaging system is executed through the key input unit 6. At Step P2, a plurality of GPS destinations are set through the key input unit 6.

At Step P3, the control unit 13 sets display of image data, records sound, and receives text according to each of the set GPS destinations. At Step P4, image data, sound data, and text data are stored in association with each of the set destinations. At Step P5, while the user is traveling along with the digital imaging system, the control unit 13 judges whether or not the user arrives at a set GPS destination.

If it is judged at Step P5 that the user arrives at the GPS destination, at Step P6, the control unit 13 judges whether or not image data, sound data, and text data associated with the received GPS destination are stored.

At Step P7, the image data, sound data, and text data associated with the GPS destination are read out. Then, the sound data is played and outputs through the speaker 9, and the image data and the text data are displayed on the display unit 8.

Here, the image data, sound data, and text data may include image data, sound data, and text files input from the outside through a USB port or a removable memory card, as well as captured images, sound data, text data generated by the user using the digital imaging system.

As such, in the digital imaging system having a GPS function, according to the above-described process, information regarding each destination is input and stored as sound or text, and, when the user arrives at the corresponding destination while traveling along with the digital imaging system, the sound or text is automatically displayed. Therefore, the user who uses the digital imaging system can rapidly know the information regarding the destination. Further, the digital imaging system having a GPS function according to the embodiment of the invention can be conveniently used as an assistant for real estate transaction or guidance to travelers.

With this configuration, if the GPS module is provided in the digital imaging system and stores map data so as to perform a GPS function, the user who uses the digital imaging system can execute the GPS function while photographing at the destinations and store the GPS positional information in association with the captured images. Therefore, the user can search the captured images later and set the imaging place of the captured image as a destination. As a result, the user can easily visit the imaging place.

As described above, according to the invention, the address and position of a destination can be input and stored in association with the previously captured image of the destination, and thus a travel plan can be stored in advance. Further, after traveling, the user can record and play the captured images and recorded sound.

Further, destinations can be set using a navigation function and information can be stored in advance before traveling according to the set destinations. Therefore, information regarding the destinations can be shown to the user through sound information or text information.

In the above-described embodiments, a case where the invention is applied to the digital imaging system having a GPS function has been described. However, the invention can be applied to a cellular phone that has a known GPS module and a camera. Further, the invention can be applied to a camcorder having a motion picture capturing function, on which a GPS module is mounted.

As described above, according to the embodiment of the invention, the digital imaging system having a GPS function stores the photographs of the destinations to remember and the imaging place information regarding the imaging places together. Therefore, the user can easily visit the imaging places.

Further, in the digital imaging system having a GPS function, the positional information of the imaging place associated with the captured image is automatically set as the destination, thereby performing the GPS function. In addition, in the digital imaging system, when the GPS function is performed, a place to visit for photographing is set as at least one GPS destination, and information regarding the set destination is input in advance to be then stored and displayed.

What is claimed is:

1. A digital imaging system comprising:
a camera unit that captures an image, digitally converts the captured image, and outputs the converted image;
an image processing unit that compresses the image captured by the camera unit;
a GPS module that receives GPS positional information;
a data storage unit that stores GPS map data;
a key input unit that has a shot button, a GPS operating button, and various input buttons;
a display unit that displays the captured image and the GPS positional information; and
a control unit that, when an image captured by the camera unit according to the operation of the key input unit is stored, controls the data storage unit to store positional information of an imaging place received by the GPS module as imaging place information together with the captured image and, when the captured image is read, controls the display unit to display the imaging place information.

2. The digital imaging system of claim 1, further comprising:
a microphone;
an audio codec that encodes/decodes a sound signal input to the microphone; and
a speaker that outputs sound,
wherein the control unit encodes the sound signal input through the microphone using the audio codec so as to convert the sound signal into sound data, and stores the converted sound data as the imaging place information together with the captured image.

3. The digital imaging system of claim 1,
wherein the control unit receives a text through the key input unit and stores the text in the data storage unit as the imaging place information together with the captured image.

4. The digital imaging system of claim 1,
wherein, when display of captured image data is selected according to the operation of the key input unit, the control unit checks whether or not GPS positional data is stored in the data storage unit, and displays the captured image on the display unit together with the GPS positional data.

5. The digital imaging system of claim 2,
wherein, when display of captured image data is selected according to the operation of the key input unit, the control unit checks whether or not the sound data is stored in the data storage unit, reads the sound data stored together with the image data, converts the read sound data into a sound signal through the audio codec, and outputs the converted sound signal through the speaker.

6. The digital imaging system of claim 3,
wherein, when display of captured image data is selected according to the operation of the key input unit, the control unit checks whether or not text data is stored in the data storage unit, reads the text stored together with the image data, and displays the read text data on the display unit.

7. The digital imaging system of claim 1,
wherein the control unit sets the GPS positional information of the imaging place stored together with the selected captured image according to the operation of the key input unit as a GPS destination and automatically performs the GPS function.

8. The digital imaging system of claim 1,
wherein the camera unit includes
a camera lens,
a CCD imaging element that picks-up light incident from the camera lens,
a CCD driver that drives the CCD imaging element,
a timing generator that generates various timing signals including a signal to control an imaging time of the CCD imaging element,
a sample and hold circuit that samples an imaging signal from the CCD imaging element so as to remove noise, and
an A/D converter that converts the imaging signal with no noise into a digital signal and outputs the converted digital signal.

9. The digital imaging system of claim 1,
wherein the key input unit includes a camera shot button, a captured image search button, a button to perform the GPS function, a button to input and store sound, a button to input and store a text, and a button to set an imaging position stored together with the captured image as a GPS destination and to automatically perform the GPS function.

10. The digital imaging system of claim 1,
wherein the data storage unit includes an internal memory that stores GPS data and a GPS execution program, and a removable memory card that stores image data captured by the camera unit, sound data, and text data.

11. The digital imaging system of claim 10,
wherein the imaging place information includes at least one of image data, sound data, and text data input through an external data input/output port or stored in the removable memory card in advance through the external data input/output port.

12. A method of storing imaging place information for a digital imaging system having a GPS module, the method comprising:
performing a camera function through a key input unit so as to capture an image;
operating the GPS module so as to receive GPS positional information of an imaging place;
storing the received GPS positional information as imaging place information together with the captured image;
receiving an instruction to display the captured image through the key input unit; and
reading imaging place information associated with the captured image to display and displaying the read imaging place information together with the captured image.

13. The method of claim 12, further comprising:
operating a GPS function through the key input unit; and
setting the positional information of the imaging place displayed together with the captured image as a destination of the GPS function.

14. The method of claim 12,
wherein the digital imaging system further includes a microphone, an audio codec that encodes a sound signal input to the microphone, and a speaker that outputs sound, and
the method further comprising:
receiving the sound signal through the microphone; and
encoding the input sound signal and storing the encoded sound signal as the imaging place information together with the captured image.

15. The method of claim 12, further comprising:
receiving a text through the key input unit; and
storing the input text data as the imaging place information together with the captured image.

16. The method of claim 12,
wherein the imaging place information includes at least one of image data, sound data, and text data input through an external data input/output port or stored in a removable memory card in advance through the external data input/output port.

17. A method of storing imaging place information for a digital imaging system of claim 1, the method comprising:
operating a GPS function through a key input unit;
setting at least one GPS destination;
receiving and storing destination information according to GPS destinations;
measuring GPS positional information received by a GPS module in real time and determining whether or not a user arrives at the set destination; and
if the user arrives at the set destination, reading corresponding destination information and displaying the read destination information.

18. The method of claim 17,
wherein the digital imaging system further includes a microphone, and an audio codec that encodes a sound signal input to the microphone, and
the receiving and storing of the destination information according to the GPS destinations includes encoding the sound signal input through the microphone and storing sound data.

19. The method of claim 17,
wherein the receiving and storing of the destination information according to the GPS destinations includes receiving and storing a text through the key input unit.

20. The method of claim 17,
wherein the destination information includes at least one of image data, sound data, and text data input through an external data input/output port or stored in a removable memory card in advance through the external data input/output port.
